(19) United States
(12) Patent Application Publication
(10) Pub. No.: US 2008/0278111 A1
(43) Pub. Date: Nov. 13, 2008

(54) Method for charging a battery of an autonomous system

(75) Inventors: Sylvie Genies, Saint Egreve (FR); Antoine Labrunie, Chambery (FR); Florence Mattera, Saint Egreve (FR)

Correspondence Address: OLIFF & BERRIDGE, PLC, P.O. BOX 320850, ALEXANDRIA, VA, 22320-4850, US

(73) Assignee: COMMISSARIAT A L'ENERGIE ATOMIQUE, Paris (FR)

(21) Appl. No.: 12/149,368

(22) Filed: Apr. 30, 2008

(30) Foreign Application Priority Data
May 11, 2007 (FR) 07 03371

(51) Int. Cl. H02J 7/00

(52) U.S. Cl. 320/101; 320/153

(57) ABSTRACT

In an autonomous system, the method for charging a power storage element from a generator comprises temperature measurement, with switching from a first charging mode to a second charging mode in which the voltage is regulated by the temperature. The first charging mode is charging at regulated current to a maximum current value which is a function of the state of charge of the power storage element and of the temperature of the power storage element. Switching is performed when the voltage at the terminals of the power storage element reaches a preset threshold value, itself a function of the value of the current and temperature of the power storage element.

### BACKGROUND OF THE INVENTION

The invention relates to a method for charging a power storage element of an autonomous system, from a generator, the method comprising temperature measurement and switching from a first charging mode to a second charging mode when the voltage at the terminals of the power storage element reaches a preset threshold value, the second charging mode being a temperature-regulated voltage charging mode.

### STATE OF THE ART

Autonomous systems using a renewable power source generally require use of storage of the power produced by intermittence. The most widely used power storage systems are electrochemical accumulators, in particular “lead-acid” batteries. However, new storage technologies, in particular nickel- or lithium-based, are emerging to meet power storage requirements.

In these systems, charging or discharging of a battery is performed under the control of a regulator. The principal role of the regulator is to manage the end of charging and the end of discharging of a battery to respectively limit overcharging and discharging to excessive levels. A large number of regulators exist on the market and differ, among other things, by how the end of charging is treated.

Charging of connection/disconnection type consists in stopping charging or discharging when the battery reaches a predefined voltage threshold. When one of these two charging or discharging limit voltages of a battery is reached, the battery is then disconnected to protect it respectively from an excessive overcharge or discharge which would be liable to damage the battery irreversibly.

Charging of floating or maintenance charge type consists in applying a constant current up to a certain voltage and then maintaining this voltage, or maintenance voltage, for a certain time to complete charging of the battery. To limit damage to the battery, for example in the case of lead batteries, regulation of the maintenance voltage as a function of the temperature can be provided to limit the secondary reaction kinetics (which increase with the temperature).

Charging of metric amp-hour type consists in measuring the power delivered to the battery and in fixing a maximum quantity of charging power to recharge the battery. For lead batteries, an overcharging coefficient is applied to compensate the current used for feedback reactions, in particular that of water electrolysis, which occur to the detriment of the main reaction. However, calculation of the energy delivered to the battery remains imprecise and the end of charging criterion remains non optimized. In most cases, this imprecision leads to excessive overcharging of the battery and, in the case of the lead technology, to a large water consumption and to corrosion of the grids.

Charging of relaxation voltage type, based on voltage measurement after a relaxation time, requires several parameters of the battery state to be known: the internal resistance, the relaxation voltage, the voltage and current applied. The relaxation time may be fairly long, for example two hours in the case of lead batteries. This presents a drawback for practical use of such a method in real time, in spite of its precision for estimating the state of charge concerning certain types of storage batteries such as Nickel Metal-Hydride (NiMH) batteries (Patent WO 2005/101042)

This state of the technique, despite the limitations inherent to the different methods used, provides as a minimum information on the maximum state of charge of the battery.

However, these limitations are enhanced by the additional constraints imposed when the battery charging process is performed by an autonomous system with a variable power source (wind power, photovoltaic, micro-hydraulic . . . ), subjected to uncontrolled environmental conditions:
When charging at constant current, the voltage is imposed by the state of charge of the battery. If the power source is fluctuating, the current can not be constant.
If the power provided by the source is weak over long periods (lack of sunlight in winter for a photovoltaic generator, insufficient wind speed for a wind power generator), the battery charging current will be weak and the charging time will be long. The error on measurement of the current is consequently liable to become non-negligible and this error will be integrated over a long time period. The calculated delivered power will therefore be very different from the power actually delivered and determination of the end of charging will be made false. The risk of overcharging will be high.
The operating temperature of the system being variable in time, the temperature of the battery will depend at least as much on the temperature of the system and of its environment as on a possible exothermal end of charging reaction.

Although in certain cases they enable excessive overcharging or discharging phenomena to be limited, none of the existing systems enables the charging time to be optimized.

### OBJECT OF THE INVENTION

The object of the invention consists in palliating the above-mentioned shortcomings and in particular in optimizing the battery charging process while at the same time preserving optimum safety and limiting internal degradation phenomena.

According to the invention, this object is achieved by the fact that the process comprises a first charging mode which is a current charging mode wherein current is regulated to a maximum value of the charging current which is a function of the state of charge of the power storage element and of the temperature.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 represents in schematic manner an autonomous system in which the process according to the invention can be implemented.

FIG. 2 represents in schematic manner the progression of the end of charging threshold voltage versus temperature for regulated current charging mode.

FIG. 3 represents in schematic manner the progression of the maximum charging current versus the state of charge of the battery in regulated current charging mode.

FIG. 4 represents in schematic manner the progression of the charging voltage versus the state of charge of the battery in regulated current charging mode.

FIG. 5 represents in schematic manner the progression of the charging current and charging voltage versus the battery charging time during a battery charge, for different temperatures.

### DESCRIPTION OF A PREFERRED EMBODIMENT OF THE INVENTION

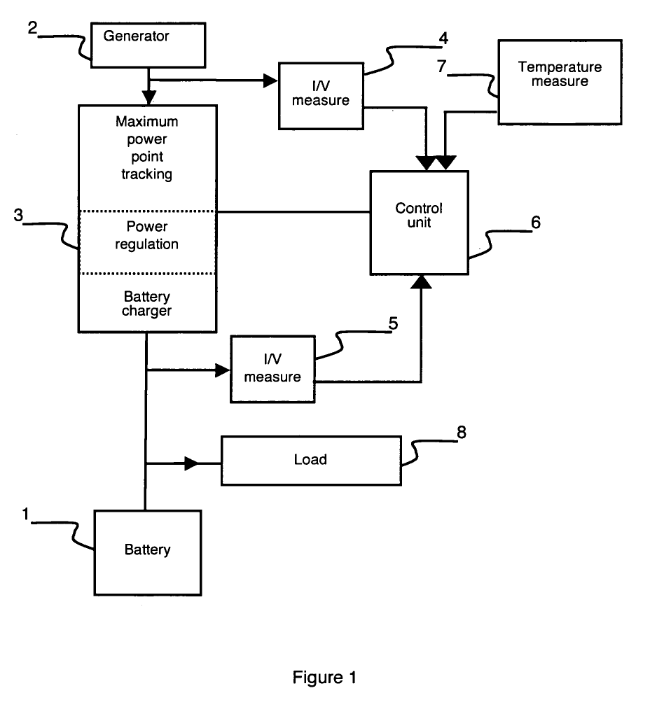

As illustrated in FIG. 1, the autonomous system comprises at least one battery 1 acting as power storage element, a power generator 2, and a power regulator 3 connected between the generator 2 and the battery 1. Measuring circuits 4 and 5, for respectively measuring the voltage and current at the output of the generator 2 and at the terminals of the battery 1, are connected to a control unit 6, also connected to the power regulator 3. A temperature measurement circuit 7 is also connected to the control unit 6. A load 8 is conventionally supplied with power by the battery 1.

The temperature measurement circuit 7 preferably comprises at least one ambient temperature measurement sensor and a measurement sensor of the temperature of the battery 1. The control unit 6 can then calculate the temperature difference between the battery 1 and its environment.

The power generator 2 is for example a photovoltaic panel or a micro-hydraulic or wind power device.

The power regulator 3 preferably comprises a BUCK-type converter. The regulator 3 also advantageously comprises a Maximum Power Point Tracking (MPPT) device and a battery charger. The control unit 6 is thus designed to perform matching, by means of the power regulator 3, between the power supplied by the generator 2 and the charge of the battery 1.

The control unit 6 can determine the power on output of the generator 2 from measurements of the voltage and current supplied by the measuring circuit 5. In known manner, the control unit 6 can determine the state of charge (SOC) of the battery 1, for example as a function of the temperature of the battery 1 and of the voltage at the terminals of the battery 1 supplied by the measuring circuit 5, and by means of empiric or modeled lookup tables.

According to the invention, charging of the battery 1 is first performed at regulated current, and then at regulated voltage when the voltage at the terminals of the battery 1 reaches a certain threshold Vthresh. Thus, the state of charge of the battery 1 having been determined and the temperature of the battery 1 having been measured, the control unit 6 is then able to calculate the maximum current acceptable by the battery 1, depending on the technology of the battery 1, its state of charge and its temperature, for charging at regulated current to maximum current. Thus current in fact represents the current not to be exceeded to ensure optimized charging of the battery 1 without causing any damage.

However, using the temperature of the battery 1 can advantageously be eliminated depending on the technology used for the battery 1.

In the case where the battery 1 is of lithium-ion type, there are no secondary reactions (no decomposition of the organic electrolyte) causing an increase of the temperature. The temperature of the battery 1 then being equal to the ambient temperature, the latter is advantageously used within the device.

In the case where the battery 1 is of lead-acid type, the temperature increase by secondary reactions may be large (for example about 60° C.), but this temperature increase only occurs at end of charging. Thus, during charging at regulated current, the temperature of the battery 1 is very close to the ambient temperature. Advantageously, a distinction between the temperature of the battery 1 and the ambient temperature can only be made at the end of charging of the battery 1.

In the case where the battery 1 is of Ni—Cd or Ni-MH type, a battery temperature increase takes place as charging is performed. End of charging of the battery 1 is detected by a faster temperature increase. The distinction between the temperature of the battery 1 and the ambient temperature must be made.

The control unit 6 then fixes the charging current at the terminals of the battery 1 at the maximum current value, by means of power the regulator 3, provided that the generator 2 can supply sufficient power.

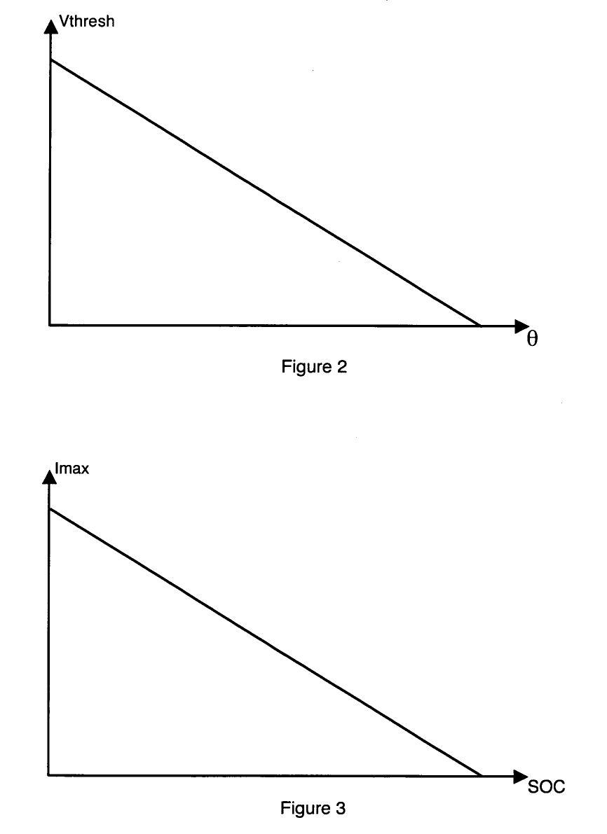

The charging current at the terminals of the battery 1 being measured by the measuring circuit 5, the control unit 6 is then able to calculate threshold voltage Vthresh as a function of the charging current at the terminals of the battery 1 and of its temperature, by means of empiric or modeled lookup tables. This threshold voltage Vthresh can for example be the voltage required to obtain 90% of the battery charge. As illustrated in FIG. 2, the threshold voltage is preferably decreasing linearly with the temperature (θ) of the battery. This threshold voltage represents the maximum voltage at the terminals of the battery 1 for which charging at regulated current up to maximum current is possible without damaging the battery 1.

In a general manner, the higher the temperature and/or the charging current, the lower the threshold voltage. FIG. 2 schematically illustrates the progression of threshold voltage Vthresh with battery temperature θ. Likewise, FIG. 5 schematically illustrates the progression of charging current I and threshold voltage Vthresh and charging voltage V versus time, for three different temperatures θ₁, θ₂, θ₃. During charging at regulated current, the charging current is equal to the maximum current Imax(θ).

The maximum current to be used during the charging phase at regulated current is continuously recalculated. In the course of charging of the battery 1, the state of charge of the battery in fact increases and the voltage at its terminals therefore also increases. As the maximum current depends in particular on the state of charge of the battery 1, it will vary during charging of the battery 1.

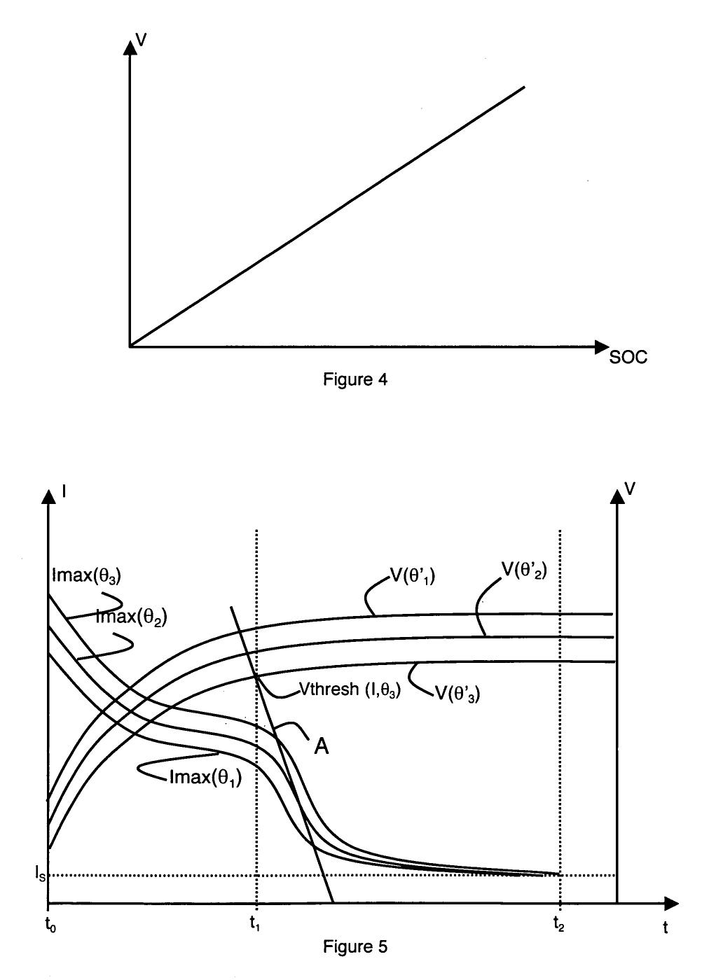

FIGS. 3 and 4 schematically represent the progression of the maximum charging current Imax admissible at the terminals of the battery 1 and of the charging voltage V versus the state of charge SOC of the battery 1. This maximum current is linearly decreasing at state of charge (SOC) and linearly increasing at voltage V. It is important to note that the maximum current acceptable by the battery 1 can be higher than the defined mean charging current, conventionally, when charging at constant current, which enables the available resources to be used to the best. Moreover, the maximum charging current depends on temperature θ of the battery 1 and increases linearly with the latter (FIG. 5).

When charging voltage V reaches threshold voltage value Vthresh, itself continuously updated in particular according to the temperature θ of the battery 1 (FIG. 2) and to the charging current, the control unit 6 then switches from regulated current charging mode to voltage charging mode regulated by ambient temperature θ′. Charging voltage V is then regulated by ambient temperature θ′. In FIG. 5, the line A illustrates switching from regulated current charging mode to voltage charging mode regulated by ambient temperature.

The control unit 6 then takes account of temperature θ of the battery 1 and ambient temperature θ′ measured by the temperature measuring circuit 7 to calculate the temperature difference between the battery 1 and the ambient temperature and the rate of progression of this temperature difference. If the temperature difference is greater than a preset threshold value (for example 1.5° C. for a sealed lead-acid battery) or if the variation rate of the temperature difference is greater than a preset threshold value (for example 2° C./hour for a sealed lead-acid battery), the control unit 6 then stops charging the battery 1.

In the opposite case, the control unit 6 continues charging the battery 1 by means of the power regulator 3, continuously fixing the value of charging voltage V according to ambient temperature θ′.

As charging of the battery 1 is performed in charging mode with the voltage regulated by ambient temperature θ′, charging current I decreases with the increase of state of charge SOC and therefore with time, as illustrated in FIG. 5. Charging current I is then used as end of charging criterion. In this way, when the charging current is equal to a preset value Is of the end of charging threshold current, the control unit 6 stops charging the battery 1. As illustrated in FIG. 5, the value of the end of charging threshold current is preferably independent from the temperature.

FIG. 5 represents for example purposes charging of a battery for different ambient temperatures. Charging current I and charging voltage V are represented versus charging time t, the latter being representative of the state of charge of the battery. Three battery temperatures θ₁, θ₂, θ₃ (θ₁<θ₂<θ₃) and three ambient temperatures with θ′₁<θ′₂<θ′₃ are illustrated in the example of FIG. 5. Only operation at ambient temperature θ′₃ will be described, operation at other temperatures being identical but staggered.

At a time t₀, the control unit 6 measures the temperature θ of the battery 1 (θ=θ₁) and the voltage at the terminals of the battery 1 by means of the temperature measuring circuit 7 and respectively measuring circuit 5. Then, using these measurements and suitable tables, the control unit 6 determines the state of charge of the battery 1 and then the maximum current Imax acceptable by the battery 1. The control unit 6 then regulates charging current I to the value Imax. This charging at regulated current continues until a time t₁ at which voltage V at the battery terminals reaches threshold voltage value Vthresh (θ,I). This threshold voltage is continuously updated according to the charging current measured by circuit 5 and to the state of charge of the battery 1.

Thus, between times t₀ and t₁, the autonomous system uses the power resources available to charge the battery 1 to the utmost.

Between t₀ and t₁, as the battery 1 is charged, the control unit 6 continuously recalculates the value of the maximum current acceptable by the battery 1, according to its temperature and its state of charge. The power regulator 3 then varies the current delivered to the battery 1 so that the latter does not exceed the maximum current value.

Between the times t₁ and t₂, charging of the battery 1 is performed at a voltage regulated by ambient temperature θ′, the charging current then decreasing until it reaches end of charging threshold current value Is. The control unit 6 then stops charging the battery 1 which is considered to be charged.

1. A method for charging a power storage element of an autonomous system from a generator, method comprising measurement of the temperature, switching from a first charging mode to a second charging mode when the voltage at the terminals of the power storage element reaches a preset threshold value, wherein the first charging mode is a current charging mode wherein the current is regulated to a maximum value of the charging current which is a function of the state of charge of the power storage element and of the temperature and wherein the second charging mode is a temperature-regulated voltage charging mode.

2. The method according to claim 1, wherein said voltage threshold value is a function of the temperature of the power storage element and of the measured charging current.

3. The method according to claim 1, wherein said voltage threshold value is linearly decreasing with increasing temperature of the power storage element.

4. The method according to claim 1, wherein said maximum charging current value is linearly increasing with the temperature and linearly decreasing with the state of charge of the power storage element.

5. The method according to claim 1, wherein in the second charging mode, the voltage is regulated by the ambient temperature.

6. The method according to claim 1, wherein charging at a voltage regulated by the temperature is interrupted when the charging current is lower than a preset current threshold.

7. The method according to claim 1, wherein charging at a voltage regulated by the temperature is interrupted if the temperature difference between the temperature of the power storage element and the ambient temperature is greater than a preset value.

8. The method according to claim 1, wherein charging at a voltage regulated by the temperature is interrupted if the rate of progression of the temperature difference between the temperature of the power storage element and the ambient temperature is greater than a preset threshold.

9. The method according to claim 1, wherein the generator is a photovoltaic panel.

10. The method according to claim 1, wherein the generator is a wind power generator.
